(19) United States
(12) Patent Application Publication
(10) Pub. No.: US 2024/0163683 A1
(43) Pub. Date: May 16, 2024

(54) METHOD, DEVICE AND SYSTEM FOR MAKING AVAILABLE A COMMUNICATION RESOURCE

(71) Applicant: ORANGE, Issy-les-Moulineaux (FR)

(72) Inventors: Tangui Le Gleau, CHATILLON CEDEX (FR); Xavier Marjou, CHATILLON CEDEX (FR); Benoit Radier, CHATILLON CEDEX (FR)

(21) Appl. No.: 18/552,725

(22) PCT Filed: Mar. 29, 2022
(86) PCT No.: PCT/FR2022/050582

§ 371 Date: Sep. 27, 2023

(30) Foreign Application Priority Data
Mar. 31, 2021 (FR) 2103308

(51) Int. Cl. H04W 16/14

(52) U.S. Cl. CPC H04W 16/14

(57) ABSTRACT

A method allowing collaboration between a plurality of (at least 3) operators that limits the need for monetary exchanges is proposed. The method includes provisioning a first communication resource by a management entity of a first operator to a management entity of a second operator in an infrastructure (Infra) including at least a third operator. The method is implemented by the management entity of the first operator and includes receiving a cooperation index relating to a previous instance of provision of a resource, the determination of a cooperation flow depending on the received cooperation index and on a datum relating to a provided resource and provision of the first resource to the management entity of the second operator depending on the determined cooperation flow.

### TECHNICAL FIELD

The context of the invention is that of operators loaning one another resources with the aim of implementing a communication service. This loan of resources is preferably devoid of financial compensation and revolves around collaboration estimated based on an operator-generated collaboration graph intended to be used to optimize collaboration with one or more other operators.

### PRIOR ART

Operators, whether they are infrastructure operators or data-space operators or even operators providing security services, are increasingly called upon to collaborate because it is very difficult, costly and complicated to control at all times, territory-wide, all the technological bricks required to offer an end-to-end service to a customer. Thus, with a view to developing new services, communications architectures, as for example specified by 3GPP for 5G services, make provision for an increasing amount of collaboration between complementary operators or operators of the same type. Thus, mobile network operators (MNOs) collaborate with one another to provide roaming data connectivity (international roaming, sometimes even national roaming) This collaboration involves reaching specific agreements per pair of operators and involves monetary exchanges to compensate for asymmetry in the resources exchanged between two operators. This collaboration generally gives rise to compensation. Thus an operator that routes data over its access networks for customers of another operator will most probably be compensated depending on the volume of data routed or depending on the number of customers who actually connect to these access networks. Although using money has certain advantages, from the point of view of the collaborating operators it has a major drawback: it forces them to go through an intermediary in the value chain, who will receive some of the financial sum associated with the transactions between operators. It will be noted that various types of resources may be exchanged between operators. Specifically, it is possible to envision techniques for sharing connectivity resources (e.g. roaming, RAN sharing, etc.) but also for sharing of other resources (radio access towers (towerco), energy resources, etc.). Given that an operator may not only be a user of another operator's resources but also a manager of resources loaned to another operator, it is also possible to envision a loan of resources that is not compensated by a payment, or not solely compensated by a payment, but rather by an exchange of resources between collaborating operators. Such collaborations between two operators are less and less rare. Thus, methods exist to encourage collaboration between two operators. In particular, many techniques exist for negotiating cooperation in dilemma situations (of prisoner's dilemma type). When these dilemmas are reiterated over time, selfish strategies that operators might use in the short term prove to be sub-optimal in the long term. One of the best-known techniques, as shown in [FIG. 1], is the tit-for-tat (TFT) algorithm, which adapts the degree of cooperation depending on the previous choice of a partner during a previous exchange of resources, for example. The main idea is to start by cooperating initially, and then subsequently to reproduce the previous choice of the partner. Thus, an operator is sure not to be exploited but also encourages mutual cooperation. However, on the one hand this technique is not optimal, and on the other hand it does not work in situations where cooperation is not systematically bilateral (an operator A is able to provide resources to an operator B that is unable to allocate resources to operator A) and in situations where it is only possible to cooperate in a circular fashion (an operator A is able to provide resources to an operator B that is able to provide resources to C, which is able to provide resources to A). This example includes 3 operators A, B, C, but it is also possible to envision collaboration between more than 3 operators. In other words, known techniques do not work in the particular case of this type of collaboration, which might be termed circular collaboration, which allows each operator in the circle to gain access to the resources of another operator that itself is unable directly to give the operator that lent it resources access to its own resources. It will be noted that techniques exist that use multi-agent learning (applicable to a multi-operator context). In particular, mention may be made of the article “The AI Economist: Improving Equality and Productivity with AI-Driven Tax Policies” (Apr. 28, 2020) or “Deep reinforcement learning models the emergent dynamics of human cooperation” (March 2021) which describe collaboration between multiple agents. However, these solutions have limited performance. The present invention aims to provide improvements with respect to the prior art.

### SUMMARY OF THE INVENTION

The invention improves the situation by virtue of a method for provision of a first communication resource by a management entity of a first operator to a management entity of a second operator in an infrastructure comprising at least a third operator, the method being implemented by the management entity of the first operator and comprising
receipt of a cooperation index relating to a previous instance of provision of a second resource by the management entity of the second operator and of a third resource by a management entity of the at least a third operator,
determination of a cooperation flow depending on the received cooperation index and on a datum relating to a fourth resource provided to the management entity of the first operator by the management entity of the second operator or of the at least a third operator,
provision of the first resource to the management entity of the second operator depending on the determined cooperation flow.

The method allows multi-operator cooperation to be implemented without a pecuniary exchange having to be defined. A pecuniary exchange may complete the method in the case where the resources provided and used by the first operator are too imbalanced, but the cooperation flow is determined so as to minimize such a pecuniary exchange and if possible make it redundant.

The method further has the advantage of involving learning in that collaboration of an operator in a previous exchange of resources is rewarded in a following exchange, promoting contribution of a higher number of operators having an interest in collaborating. As a corollary, an operator will be penalized for a deficient contribution or an abandonment and its contribution to future collaboration disfavored.

This method further allows operators to limit their investments by promoting provision of resources by the operators and thus to make maximum use of all the resources deployed by the various operators in a given space. The method therefore also has regard to the preservation of resources since an operator will be able to privilege contribution to such a method rather than an investment in new resources that may be underused. Each operator is therefore able to limit its investment and operating expenses (radio access stations, purchase of frequencies, energy resources or even network maintenance equipment or vehicles, which may be considered equipment contributing to communication enablement).

This method is all the more advantageous in that it does not require the first operator providing resources to a second operator to employ, in return, resources provided thereto by the second operator, which if it were not the case might limit bilateral collaboration.

According to one aspect of the invention, in the provision method the cooperation index comprises a maximum cooperation flow rate corresponding to an amount of the second and third resources received from the management entities of the second operator and of the at least a third operator.

Use of a maximum cooperation flow rate makes it possible to consider the system and not merely a single operator and makes it possible to determine whether a system, in the present case comprising 3 operators, is tending toward greater collaboration or not and, where appropriate, whether it would be desirable to integrate another operator into the system.

According to another aspect of the invention, in the provision method, the cooperation index is specific to each management entity of the infrastructure.

Use of a maximum cooperation flow rate makes it possible to consider the system and not merely a single operator and makes it possible to determine whether a system, in the present case comprising 3 operators, is tending toward greater collaboration or not and, where appropriate, whether it would be desirable to integrate another operator into the system.

According to another aspect of the invention, in the provision method the cooperation flow is further determined depending on a datum relating to a fifth resource provided by the management entity of the second operator to the management entity of the at least a third operator.

The method is based on a virtuous circle that should allow each operator to benefit from collaboration. The cooperation flow is therefore especially advantageous in that not only does the first operator balance its provided and used resources with the second and third operator, but also the second and third operator profit therefrom through the resource provided by the second operator to the third operator.

According to another aspect of the invention, in the provision method the cooperation flow is determined depending on the number of operators participating in the provision of the first resource.

Since the method is based on the one hand on learning and regularly updating a cooperation index, and on the other hand on a greater diversity in the resources provided to the operators, the cooperation flow is advantageously determined depending on the number of operators, which should be as high as possible, in particular to promote future collaboration, and possibly on the types of resources, or even takes into account spatial constraints on resource availability. In the case where an operator seeks a privileged agreement with other operators, the number of operators involved in the method may be limited to a low number. It will be noted that the method is dynamic and that methods involving more or fewer operators may be implemented. Thus, a provision method may involve 3, 4, 5 or more operators in a context where at least 5 operators may potentially be involved.

According to another aspect of the invention, the provision method further comprises, following provision of the first resource, dispatch, to a mediation entity, of a message containing information relating to the first resource and an identifier of the management entity of the second operator.

This provision makes it possible to be able to inspect, afterwards, the resources shared and the operators that actually used the resources of other operators. Blockchain technology may for example be used to update the mediation entity. Recording provision in this way also allows the regulator/auditor managing the mediation entity to verify the progress of cooperation and to verify that no duopolies or alliances have formed to the detriment of one or more operators participating in the method. The identifier relating to the first resource may advantageously contain an identifier of the management entity of the first operator.

According to another aspect of the invention, the provision method further comprises, prior to receipt of the cooperation index, receipt of information relating to mutual provision of the second and third resources by the management entities of the operators of the infrastructure.

This information may advantageously be used to select the operators involved in the method.

According to another aspect of the invention, in the provision method the cooperation flow is determined depending on an amount of the first resource and on an amount of the fourth resource.

Given that one of the objectives of the method is to limit transfers of money between operators, the cooperation flow must be optimized so that the amount or value of the resources used is balanced with the resources provided and so that each operator collaborates in accordance with this objective.

According to another aspect of the invention, in the provision method, the cooperation index is determined depending on a cooperation index determined during a previous instance of provision of a resource.

The method is all the more advantageous in that it is iterative and that the cooperation index is a value that varies depending on the provision of resources between the operators involved in the method. This variation may allow a new operator to be asked to get involved with a view to getting it to increase or the participation of an operator to be revoked if it is lowering the index.

According to another aspect of the invention, in the provision method, the first resource and the fourth resource are identical.

In one particular case, the resources provided are identical and are for example spatially dispersed, thus allowing an operator to widen his area of operation, or indeed temporally dispersed, allowing an operator to compensate for a lack of resources during an event or a peak in activity.

The various aspects of the provision method that have just been described may be implemented independently of one another or in combination with one another.

The invention also relates to a device of a first operator for provision of a first communication resource to a management entity of a second operator in an infrastructure comprising at least a third operator, comprising:
a receiver able to receive a cooperation index relating to a previous instance of provision of a second resource by the management entity of the second operator and of a third resource by a management entity of the at least a third operator,
a determination module, able to determine a cooperation flow depending on the received cooperation index and on a datum relating to a fourth resource provided to the management entity of the first operator by the management entity of the second operator or of the at least a third operator,
a provision module, able to provide the first resource to the management entity of the second operator.

This device, which is able to implement all the embodiments of the provision method that has just been described, is intended to be implemented in a management entity of a fixed or mobile network of an operator and may in particular be instantiated in a PCF device of an operator's network in a virtualized form or in the form of physical equipment.

The invention also relates to a system for provision of a first communication resource by a management entity of a first operator to a management entity of a second operator in an infrastructure comprising at least a third operator, comprising:
a provision device of a management entity,
at least two additional management entities.

The invention also relates to a computer program comprising instructions for implementing the steps of the provision method that has just been described when this program is executed by a processor, and to a storage medium able to be read by a provision device on which the computer program is stored, respectively.

The aforementioned data medium may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc.

Moreover, a data medium may be a transmissible medium such as an electrical or optical signal, which may be routed via an electrical or optical cable, by radio or by other means. A program according to the invention may in particular be downloaded from a network such as the Internet.

Alternatively, an information medium may be an integrated circuit in which a program is incorporated, the circuit being designed to execute or to be used in the execution of the method in question.

### BRIEF DESCRIPTION OF THE DRAWINGS

Other features and advantages of the invention will become more clearly apparent on reading the following description of particular embodiments, which are given by way of simple illustrative and non-limiting examples, and the appended drawings, in which:

FIG. 1 shows a simplified view of a multi-operator communication infrastructure according to a technique of the prior art,

FIG. 2 shows a simplified view of a communication infrastructure in which the provision method according to one aspect of the invention is implemented,

FIG. 3 shows a simplified view of a communication infrastructure resulting from implementation of the provision method according to another aspect of the invention,

FIG. 4 shows an overview of the provision method according to one embodiment of the invention,

FIG. 5 shows an example of a maximal graph and of a maximal flow rate of a provision method according to one embodiment of the invention,

FIG. 6 shows an example of a provision method based on maximal graphs and on maximal flow rates according to one embodiment of the invention,

FIG. 7 shows a provision device according to one embodiment of the invention.

### DESCRIPTION OF THE EMBODIMENTS

In the remainder of the description, embodiments of the invention are presented in a communication infrastructure. This infrastructure may be employed to route communication data to fixed or mobile terminals and the functions of this infrastructure may for example be virtualized functions or specific equipment used to route and/or process data of residential or business customers.

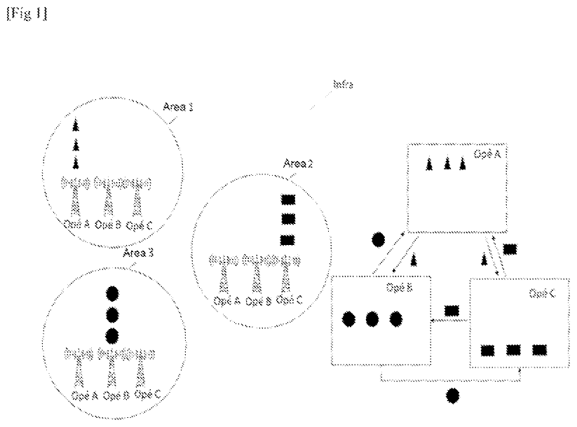

Reference will first be made to [FIG. 1], which shows a simplified view of a multi-operator communication infrastructure according to a technique of the prior art. The communications infrastructure Infra comprises three areas in which three operators Opé A, Opé B and Opé C operate communications networks, for example of the mobile communications networks. In this example, the communication resources are for example communication towers. Thus in each area Area 1, Area 2, Area 3, the 3 operators Opé A, Opé B and Opé C have communications resources. It may be seen that operator Opé A has 3 communication capacities in area 1, that operator Opé B has 3 communication resources in area 3 and that operator Opé C has 3 communication resources in area 2. It may therefore be seen that, in this situation, none of the operators has communication resources in all the areas, this potentially being detrimental, for example when it is desired to provide a customer of an operator access to resources when this customer is in an area where the operator with which she or he has taken out a subscription to a service does not have any resources. A customer of operator Opé C who is in area 1 will thus not be able to access communication services. It would therefore be desirable for the operators Ope A, Opé B and Opé C to be able to exchange resources, so that each operator could gain access to communication resources in each area Area 1, Area 2 and Area 3.

The operators Opé A, Opé B, Opé C might thus implement a Tit-for-Tat (TFT) technique as indicated above, and thus operator Opé A must agree with the operator Opé B (operator Opé A providing a triangular resource in exchange for a circular resource provided by operator B) and operator Opé A must further exchange resources with operator Opé C (operator Opé A providing a triangular resource in exchange for a rectangular resource provided by operator C). Such a method therefore requires each operator Opé A, Opé B and Opé C to exchange resources with each of the other operators and therefore each operator to know the other operators or even to have entered into contracts with each of the other operators. Such a solution therefore requires a large volume of exchanges, proportional to the number of operators, since it would be recommendable to envision a communications infrastructure allowing a higher number of operators to operate. Such a solution is therefore not optimal.

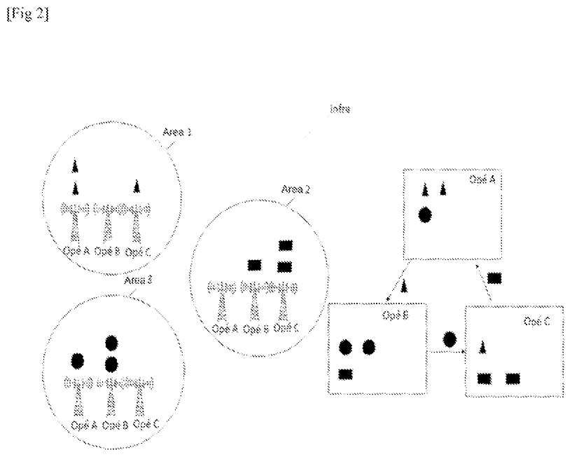

Reference will now be made to [FIG. 2], which shows a simplified view of a communication infrastructure in which the provision method according to one aspect of the invention is implemented.

The communications infrastructure is identical to the infrastructure of [FIG. 1], except that the distribution of resources in areas Area 1, Area 2 and Area 3 is different. It will be noted that the provision method may be implemented between the operators Opé A, Ope B and Opé C regardless of the type of resources, the number of resources, or the place where the resources are available. Thus, it is possible to envisage the provision of access resources (electromagnetic frequencies, radio-tower transmission capacity, etc.), communication network routing capacities, software resources or indeed energy resources.

In [FIG. 2], operator Opé A has two access capacities (represented by triangles) in Area 1, while operator Opé C has only one access capacity and operator Opé B has no triangular resources in this area Area 1. In Area 2, operator Opé B has one access capacity (represented by a rectangle) and operator Opé C has two rectangular access capacities, while operator Opé A has none of these rectangular capacities in Area 2. Lastly, in Area 3, operator Opé A has one access capacity (represented by a circle), operator Opé B has two circular access capacities, and, in Area 3, operator Opé C has no circular access capacities.

One of the objectives of the provision method is for each operator Opé A, Opé B and Ope C to have access to a maximum of the different types of resources (triangle, circle, rectangle) in each area, while limiting the number of monetary exchanges between operators and while avoiding pecuniary exchange, this meaning that the exchange of resources between operators must be balanced and that each operator must receive an amount of resources that is as close as possible to the amount of resources provided thereby. It will be noted that if an operator exchanges resources only with one other operator, it will not be able to gain access to the entire diversity of the resources. Thus, if operator Opé A only exchanges resources with operator Opé C, the two operators will not be able to exchange the circular resource since operator Opé A has only one. It would therefore be recommendable to implement a novel and inventive provision method. The provision method is implemented between management entities of the three operators Opé A, Opé B and Opé C and for example, operator A will compute a cooperation index for each operator Opé B and Opé C, this index being updated each time resources are exchanged, independently of the type of resources. For example, if operator Opé B provided a large amount of resources and Opé C did not provide any resources during a previous implementation of provision of resources, the cooperation index will be modified to take into account these past instances of provision. This index may be specific to each operator Opé B and Opé C and/or it may be an overall cooperation index relating cooperation of the operators in the communication infrastructure Infra. Depending on the received cooperation index, and on its variation, and depending on the amount of resources of another operator (Opé C) that operator A is actually able to use, the management entity of operator Opé A determines a cooperation flow. Specifically, operator A may provide a triangular resource to operator B but require a rectangular resource that operator B cannot provide but that operator Opé C is actually able to provide. It is therefore not a question of a bilateral negotiation between operator Opé A and operator Opé C (or operator Opé B) but of a cooperation flow involving all three operators, the exchanges between the operators being dependent on the cooperation index but also on the volumes of resources provided on the one hand and used on the other hand to limit pecuniary exchanges. The nature or types of resources provided by the operators may be communicated by each operator to each of the other operators or indeed communicated to a centralized register that the management entities of the operators Opé A, Opé B and Opé C are able to access.

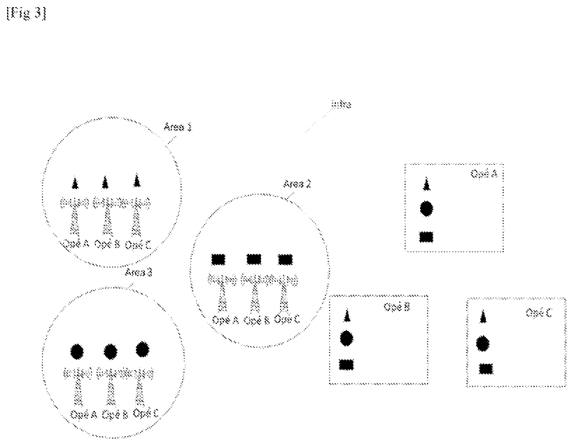

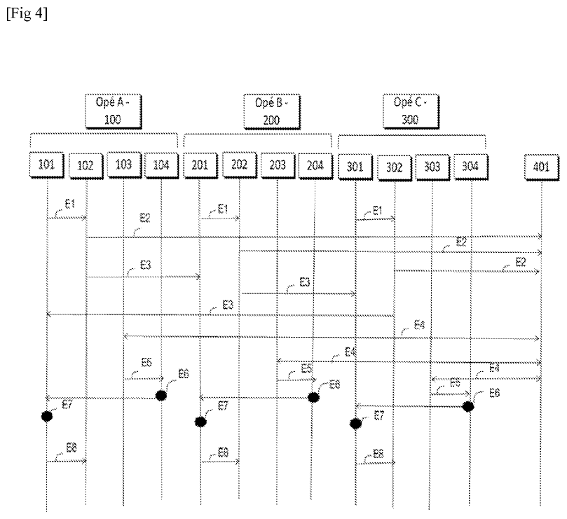

Thus, in [FIG. 2], a cooperation flow, which may be qualified circular, is set up, operator Opé A providing operator Opé B with a triangular resource, operator Opé B providing operator C with a circular resource and operator Opé C providing operator Opé A with a rectangular resource. This collaboration is made possible through computation of a received cooperation index by the management entity of operator Opé A, promoting collaboration with operators Opé B and Opé C and provision of the triangular resource depending on use of the rectangular resource, these two resources being provided or used by two separate operators themselves having provided one resource. This provision may be implemented with a higher number of operators, the resources being exchanged between operators forming a circle, depending on the actual and regularly updated collaboration of the operators. Furthermore, the resources may be of the same type (for example only triangles) or indeed of different type and it is possible to weight each resource to adjust the balance of exchanges between the operators.

[FIG. 3] shows a simplified view of a communication infrastructure resulting from implementation of the provision method according to one aspect of the invention. Once the operators Opé A, Opé B and OpéC have contributed to the method for provision of a resource (here represented by the triangular resource if the method is considered to be implemented by a management entity of operator Opé A) each operator Opé A, Opé B and Opé C has one communication resource in each area Area 1, Area 2 and Area 3 without operator Opé B having provided a resource to operator Opé A, and therefore without reciprocity in the provision of a resource between the operators Opé A and Opé B, operator Opé C and possibly other operators instead being made to contribute in a circular cooperation flow. The 3 areas, Area 1, Area 2 and Area 3, may be a single area, and it is possible to implement the provision method in the absence of spatial constraint.

[FIG. 4] shows an overview of the provision method according to one embodiment of the invention. In this method, three operators Opé A, Opé B and Opé C, which may for example be mobile network operators, are involved in the provision method, and each operator Opé A, Opé B and Opé C comprises at least one agent (101, 201, 301, respectively) in charge of performing cooperative actions with other agents (101, 201, 301). Specifically, an operator could, according to one example, comprise more than one agent. In this embodiment, operator Opé A is considered to be the operator implementing the provision method. The operators Opé A, Opé B and Opé C further comprise an entity 102, called a strategy function, which decides on the actions to be taken in respect of the other agents 201 and 301 depending on the degree of cooperation received in previous instances of provision.

Operator Opé A is here considered to be able to provide radio frequencies for a time t. Operator Opé A further comprises a detection function 103 that detects cooperation choices that the other agents made during a previous instance of provision. It is so to speak a function that is symmetrical to the strategy function, since it aims to detect past cooperation while the strategy function aims to choose which actions to take during future cooperation. The operators Opé B and Opé C correspondingly comprise respective detection functions 203 and 303. Operator Opé A further comprises a negotiation function 104 that to one level of cooperation reciprocates with another level of cooperation, so as to encourage the cooperation of the other operators Opé B and Opé C and to penalize exploitation (use but not provision of resources) and abandonment (withdrawal of an operator during provision). A management entity 100 comprising the agent 101 and the strategy function 102 collaborates with the detection and negotiation functions 103 and 104 to implement a communication-resource provision method. Operators Opé B and Opé C also have negotiation functions 204 and 304 corresponding to function 104.

Agent 101 further has internal variables:
Cₘₐₓ^{k} (step 0: C̅ₘ̅ₐ̅ₓ̅): a maximal cooperation graph that agent 101 modifies each time a provision method is implemented.
Dₘₐₓ^{k}: (step 0: D̅ₘ̅ₐ̅ₓ̅^̅{̅k̅}̅) a maximal cooperation flow rate that the agent 101 is ready to “deliver”, depending on provision history, and that it modifies depending on whether it is cooperating more or less than the other agents.

The management entity of the operator Opé A may for example be a PCF device (PCF standing for Policy Control Function) of a mobile network, and the functions 103 and 104 may for example be included in an NWDAF device (NWDAF standing for Network Data Analytics Function) of a mobile network.

Operators Opé B and Opé C may also implement the provision method, but each agent 201 and 301 should contribute to the method as indicated below.

The communication infrastructure further comprises a register 401 able to communicate with the agents 101, 201, 301. This register may for example be a DLT register (DLT standing for Distributed Ledger Technologies). This register 401 may be managed by one of the operators Opé A, Opé B and Opé C, or indeed be managed by an entity external to the operators.

In a step E1, agent 101 communicates to its strategy function 102 degrees of cooperation, having a value comprised between 0.0 and 1.0, with the operators Opé B and Opé C. A value of 0.0 corresponds to zero cooperation and a value of 1.0 corresponds to full cooperation. This degree of cooperation corresponds to its willingness to perform a cooperative action of provision to the other agents 201 and 301. In the same step E1, the agents 201 and 301 are considered to communicate, in a corresponding manner, their degrees of cooperation to their corresponding strategy functions.

In a step E2, strategy function 102 transmits to the register 401 a message containing the frequencies (the resources for example being frequencies) that it is actually able to provide depending on the degrees of cooperation communicated during a previous instance of provision of resources. Thus the agent 101 indicates in this message, the type of resource and the volume of this resource that it is able to provide to each agent 201 and 301.

This message may take the following form:

The management entity of operator Opé A, via the strategy function 102, transmits the following information:
Source: agent-101, Destination: agent-201, Resource-A: 1 unit
Source: agent-101, Destination: agent-201, Resource-B: 0 unit
Source: agent-101, Destination: agent-201, Resource-C: 0 unit
Source: agent-101, Destination: agent-301, Resource-A: 0 unit
Source: agent-101, Destination: agent-301, Resource-B: 0 unit
Source: agent-101, Destination: agent-301, Resource-C: 0 unit

Thus, agent 101, in this message, indicates that it is able to provide frequencies corresponding to resource A to agent 201.

Correspondingly, in step E2, agents 201 and 301, via the strategy functions 202 and 302, transmit a message indicating the resources that they are able to provide. The resources B are considered to be energy resources, and the resources C are considered to be transport-network transmission capacities.

The strategy function 202 transmits the following information to register 401:
Source: agent-201, Destination: agent-101, Resource-A: 0 unit
Source: agent-201, Destination: agent-101, Resource-B: 0 unit
Source: agent-201, Destination: agent-101, Resource-C: 0 unit
Source: agent-201, Destination: agent-301, Resource-A: 0 unit
Source: agent-201, Destination: agent-301, Resource-B: 1 unit
Source: agent-201, Destination: agent-301, Resource-C: 0 unit

The strategy function 302, correspondingly, transmits, in step E2, the following information to register 401:
Source: agent-301, Destination: agent-101, Resource-A: 0 unit
Source: agent-301, Destination: agent-101 Resource-B: 0 unit
Source: agent-301, Destination: agent-101, Resource-C: 1 unit
Source: agent-301, Destination: agent-201, Resource-A: 0 unit
Source: agent-301, Destination: agent-201, Resource-B: 0 unit
Source: agent-301, Destination: agent-201, Resource-C: 0 unit

This information may advantageously be transmitted by the strategy functions and saved by the register 401 using blockchain technologies.

In step E3, each strategy function executes the provision action identified in step E2. Thus, strategy function 102 informs agent 201 that a frequency or a range of frequencies has been provided. Correspondingly, strategy function 202 informs agent 301 that an energy resource or a volume of energy resources has been provided. Strategy function 302 informs agent 101 that a volume of transport-network transmission capacities has been provided.

This provision information may advantageously be communicated using the N24 interface as specified in document 3GPP 29.513. Once the resources have been provided, the strategy functions 102, 202, 302 may update a mediation entity in charge of monitoring provision. According to one particular case, this mediation entity may be the register 401.

In a step E4, detection entity 103 retrieves, from register 401, instances of cooperation, corresponding to the resources provided by the agents 201 and 301 in step E3. Correspondingly, detection entity 203 obtains respective instances of provision by agents 101 and 301, and detection entity 303 obtains respective instances of provision by agents 101 and 201.

In a step E5, the detection entity 103 (203 and 303, respectively) communicates to the negotiation entity 104 (204 and 304, respectively) the instances of provision obtained in step E4.

In a step E6, the management entity of Opé A 100 receives, from the negotiation function 104, a cooperation index updated depending on the previous instance of provision of energy resources (the resources are according to this example of energy resources) by the management entity of Opé B 200 (the management entity comprising entities 201 and 202) of the operator Opé B, and the previous instance of provision of transmission capacities by a management entity of Opé C 300 (comprising entities 301, 302) of the operator Opé C.

Advantageously, the cooperation index comprises a modification of a maximal cooperation flow rate Dₘₐₓ¹ corresponding to an amount of frequencies provided by entity 200 of the operator Opé B. This cooperation index may be specific to operators Opé B and Opé C or it may be an overall cooperation index expressing a degree of cooperation between all the operators involved. The entities 200 and 300 also update cooperation indices in step E6.

This update of cooperation index may also comprise modifying the maximal cooperation graph Cₘₐₓ¹ by penalizing edges that are directed toward the management entities of uncooperative operators.

In a step E7, agent 101, on the basis of the updated cooperation index, which entity 104 will have communicated in step E6 if the two entities are not co-located, determines a cooperation flow depending on the updated index and depending on whether it is possible to actually use a resource provided by one of the management entities of the operators of the communication infrastructure. Specifically, the management entity of Opé A 100 accepts to provide a resource if it was previously able to receive a resource provided by a management entity of another operator. The resources provided by operators Opé B and Opé C may be communicated to it directly by the operators in question or indeed by the register 401, which may collect provision offers. The management entity of Opé A 100 therefore determines a cooperation flow, consisting in a series of one-to-one instances of exchange between at least 3 operators. This cooperation flow, which is said to be circular, allows a resource to be provided to operator Opé B or Opé C while being able to use a resource provided by operator Opé C or Opé B.

This cooperation flow will possibly also be determined depending on provision of a resource by the management entity (comprising the entities 201 and 202) of the operator Opé B 200 to the management entity (comprising the entities 301 and 302) of the operator Opé C 300, so as to make collaboration more virtuous and so that each operator Opé A, Opé B and Opé C profits from this provision of multi-operator resources.

Likewise, the cooperation flow may be determined depending on the number of operators involved in the provision method. It may be advantageous for a maximum number of operators to be involved, to improve the cooperation index in respect of future searches for resources and of future provision of resources.

Advantageously, the cooperation flow is determined depending on the amount of resources provided to operator Opé B by operator Opé A and on the amount of resources that operator Opé C provides to operator Opé A. These amounts may further be weighted depending on the nature of the resource.

According to one alternative, in step E7, agent 101, after having determined a new maximal cooperation graph Cₘₐₓ¹ and a new maximal cooperation flow rate Dₘₐₓ¹, searches for a cooperation flow in the maximal graph Cₘₐₓ¹ encompassing a maximum number of agents and therefore operators, on the basis of a virtuous circle that benefits the highest number of operators and promotes future collaboration.

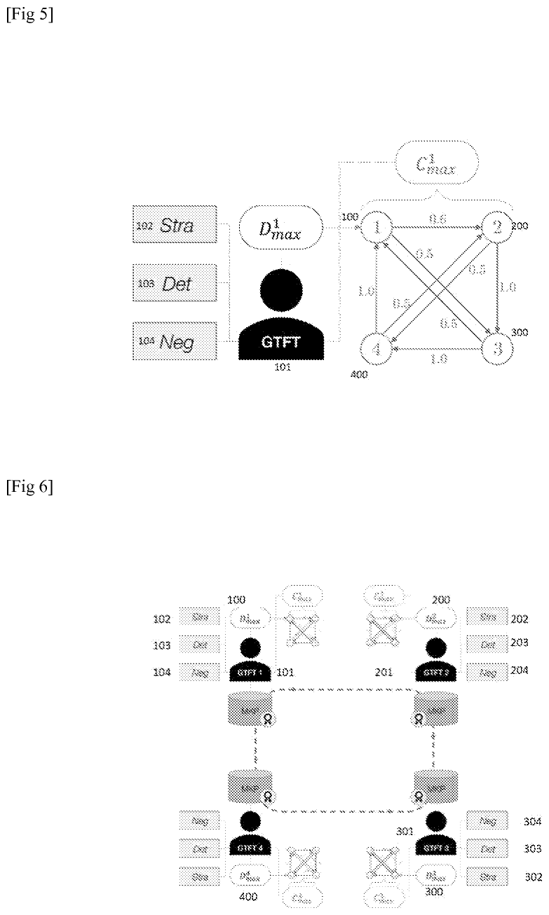

One example of a maximal graph and of a maximal flow rate is illustrated in [FIG. 5]. The three functions 102, 103 and 104, i.e. the strategy function (Stra), detection function (Det) and negotiation function (Neg), have been shown for agent 101, which implements a GTFT provision method (GTFT standing for Graph-based Tit-for-Tat) in the presence of 4 operator management entities (100, 200, 300, 400), with confidence indices between these management entities. [FIG. 6] shows one example of a provision method based on maximal graphs and maximal flow rates between 4 operator management entities 100, 200, 300, 400 each implementing the provision method. Thus, a provision circle linking the various operator management entities is constructed and allows each management entity to provide a resource while using a resource from another entity in the circle.

This step, step E7, according to one example, is broken down into two sub-steps:
Construction of a flow graph: the capacities are the max degrees of cooperation, the source (agent 101) is linked to the input of the node corresponding to itself with the capacity Cₘₐₓ^{k} and all edges directed towards itself are recentered on the sink. Thus a flow graph is obtained that aims to cause a maximum of cooperation to circulate among the agents so that a maximum of resources are provided in a circular fashion.
Detection of the max flow in this new graph via dedicated algorithms (for example Ford-Fulkerson algorithms) This step makes it possible to obtain the sub-graph allowing a maximum circulation of cooperation between the agents (101, 201, 301) to be achieved while “receiving” (i.e. while providing resources) as much as “given” (i.e. while being able to use the resources of another operator (Opé B, Opé C)).

In a step E8 (corresponding to step E1) agent 101 (and agents 201 and 301, respectively) transmits, to its strategy function 102 (202 and 302, respectively), the degrees of cooperation with the operators Opé B and Opé C, these degrees of cooperation being updated with the previous instance of provision of resources. Thus an adaptive provision method is implemented that takes into account variation in the cooperation of the various operators (Opé A, Opé B, Opé C) involved in the provision of resources. This method is especially advantageous when a high number of operators are involved in the method, each operator being able to get involved, or not, in a provision cycle (Steps E1 to E7). It will be noted that step E2 is optional and that each strategy function (102, 202, 302) could inform the other agents rather than the register 401. Agent 102 could also update the cooperation index depending on the resources actually provided to it.

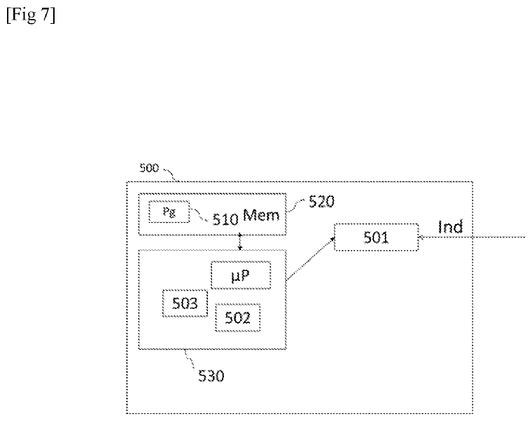

Provision may have different meanings depending on the type of resources and/or the strategy of the operators involved in the method. It may be a loan of resources, for example for a set time, or indeed a right to use these resources or even delivery of technical elements (access information, security keys, etc.) allowing resources to be accessed. Such provision in particular differs from roaming since roaming consists in routing traffic over a network of another operator and, furthermore, roaming is bilateral whereas the provision method is particularly valid in a multilateral context with at least three operators.

[FIG. 7] shows a provision device 500 according to one embodiment of the invention. Such a provision device may be implemented in a management entity of a fixed or mobile network of an operator and may in particular be instantiated in a PCF device of an operator's network in a virtualized form or in the form of physical equipment. The provision device 500 may be comprised in a management entity of an operator, such as the entity (101, 102) of the first operator of [FIG. 4].

For example, the device 500 comprises a processing unit 530, for example equipped with a microprocessor μP, and driven by a computer program 510 stored in a memory 520 and implementing the provision method according to the invention. On initialization, the code instructions of the computer program 510 are for example loaded into a RAM memory, before being executed by the processor of the processing unit 530. Such a provision device 500 of a first operator comprises:
a receiver (501) able to receive a cooperation index Ind relating to a previous instance of provision of a second resource by a management entity of a second operator and of a third resource by a management entity of at least a third operator,
a determination module (502), able to determine a cooperation flow depending on the received cooperation index Ind and on a datum relating to a fourth resource provided to the management entity of the first operator by the management entity of the second operator or of the at least a third operator,
a provision module (503), able to provide the first resource to the management entity of the second operator depending on the determined cooperation flow.

1. A method comprising:
provisioning a first communication resource by a management entity of a first operator to a management entity of a second operator in an infrastructure comprising at least a third operator, the provisioning being implemented by the management entity of the first operator and comprising :
receiving a cooperation index relating to a previous instance of provision of a second resource by the management entity of the second operator and of a third resource by a management entity of the at least a third operator,
determining a cooperation flow depending on the received cooperation index and on a datum relating to a fourth resource provided to the management entity of the first operator by the management entity of the second operator or of the at least a third operator, and
provisioning the first resource to the management entity of the second operator depending on the determined cooperation flow.

2. The method as claimed in claim 1, wherein the cooperation index comprises a maximum cooperation flow rate corresponding to an amount of the second and third resources received from the management entities of the second operator and of the at least a third operator.

3. The method as claimed in claim 1, wherein the cooperation index is specific to each management entity of the infrastructure.

4. The method as claimed in claim 1, wherein the cooperation flow is further determined depending on a datum relating to a fifth resource provided by the management entity of the second operator to the management entity of the at least a third operator.

5. The method as claimed in claim 1, wherein the cooperation flow is determined depending on a number of operators participating in the provision of the first resource.

6. The method as claimed in claim 1, further comprising, following provision of the first resource, transmitting, to a mediation entity, a message containing information relating to the first resource and an identifier of the management entity of the second operator.

7. The method as claimed in claim 1, comprising, prior to receipt of the cooperation index, receiving information relating to mutual provision of the second and third resources by the management entities of the operators of the infrastructure.

8. The method as claimed in claim 1, wherein the cooperation flow is determined depending on an amount of the first resource and on an amount of the fourth resource.

9. The method as claimed in claim 1, wherein the cooperation index is determined depending on a cooperation index determined during a previous instance of provision of a resource.

10. The method as claimed in claim 1, wherein the first resource and the fourth resource are identical.

11. A device of a first operator for provision of a first communication resource to a management entity of a second operator in an infrastructure comprising at least a third operator, comprising:
a receiver able to receive a cooperation index relating to a previous instance of provision of a second resource by the management entity of the second operator and of a third resource by a management entity of the at least a third operator,
at least one processor; and
at least one non-transitory computer readable medium comprising instructions stored thereon which when executed by the at least one processor configure the device to:
determine a cooperation flow depending on the received cooperation index and on a datum relating to a fourth resource provided to the management entity of the first operator by the management entity of the second operator or of the at least a third operator, and
provide the first resource to the management entity of the second operator depending on the determined cooperation flow.

12. A system comprising:
a provision device of a first operator for provision of a first communication resource to a management entity of a second operator in an infrastructure comprising at least a third operator, comprising:
a receiver able to receive a cooperation index relating to a previous instance of provision of a second resource by the management entity of the second operator and of a third resource by a management entity of the at least a third operator,
at least one processor; and
at least one non-transitory computer readable medium comprising instructions stored thereon which when executed by the at least one processor configure the device to:
determine a cooperation flow depending on the received cooperation index and on a datum relating to a fourth resource provided to the management entity of the first operator by the management entity of the second operator or of the at least a third operator, and
provide the first resource to the management entity of the second operator depending on the determined cooperation flow;
the management entities of at least the second and third operators.

13. (canceled)

14. A non-transitory computer readable storage medium on which a computer program comprising instructions is stored, which when executed by at least one processor of a provision device configures the provision device to implement a method to provision a first communication resource to a management entity of a second operator in an infrastructure comprising at least a third operator, the method comprising:
receiving a cooperation index relating to a previous instance of provision of a second resource by the management entity of the second operator and of a third resource by a management entity of the at least a third operator,
determining a cooperation flow depending on the received cooperation index and on a datum relating to a fourth resource provided to the management entity of the first operator by the management entity of the second operator or of the at least a third operator, and
providing the first resource to the management entity of the second operator depending on the determined cooperation flow.
